(19) United States
(12) Patent Application Publication
(10) Pub. No.: US 2007/0285200 A1
(43) Pub. Date: Dec. 13, 2007

(54) Surface mount inductor

(75) Inventor: Ming Yen Hsieh, Taoyuan Hsien (TW)

Correspondence Address: CHARLES E. BAXLEY, ESQ., 90 JOHN STREET, THIRD FLOOR, NEW YORK, NY, 10038, US

(73) Assignee: Tai-Tech Advanced Electronics Co., Ltd.

(21) Appl. No.: 11/452,064

(22) Filed: Jun. 13, 2006

(51) Int. Cl. H01F 27/02

(52) U.S. Cl. 336/83

(57) ABSTRACT

A surface mount inductor includes a core having two erected side panels each having a conductor contact attached to a lower portion, and a central part coupled between the side panels for forming an H-shaped core, a wire wound around the central part of the core and having two terminals coupled to the conductor contacts of the core, and a casing having a chamber formed between a front plate and a rear plate and an upper plate for receiving the core and for forming an improved structure having a decreased height, and the central part of the core is opened for allowing the wire to be easily and quickly wound onto the central part of the core.

### BACKGROUND OF THE INVENTION

1. Field of the Invention

The present invention relates to a surface mount inductor, and more particularly to a surface mount inductor including an improved structure having a suitable or decreased height and for being easily and quickly manufactured.

2. Description of the Prior Art

Typical surface mount inductors comprise a drum-shaped core including a top flange, a bottom flange, and a central part interposed between the top and bottom flanges, and a wire wound around the central part of the drum-shaped core.

For example, U.S. Pat. No. 5,751,203 to Tsutsumi et al. discloses one of the typical surface mount inductors also comprising a wire wound around a central part of a drum-shaped core which includes a top flange disposed on top of the central part and a bottom flange disposed on the bottom portion of the central part, for allowing the central part to be interposed between the top and bottom flanges.

Normally, the typical surface mount inductors are required to be made as short as possible. However, the top and bottom flanges should include a suitable height or thickness such that the height or length of the central part will be limited, and such that the typical surface mount inductors may not be made to the required height.

U.S. Pat. No. 6,292,081 to Armfield et al. discloses another typical surface mount inductor comprising a core substantially toroidal in shape, and a wire wound around the toroidal core. However, the toroidal core is erected such that the typical surface mount inductors include a great height. In addition, the wire is required to be engaged into and out of the center hole of the toroidal core a number of times, such that the typical surface mount inductors may not be made in great speed.

U.S. Pat. No. 7,042,324 to Watanabe discloses a further typical surface mount inductor also comprising a drum-shaped core including a central part, a top flange disposed on top of the central part, a bottom flange disposed on the bottom portion of the central part, and a wire wound around the central part of the drum-shaped core. However, similarly, the top and bottom flanges should include a suitable height or thickness such that the height or length of the central part will be limited, and such that the typical surface mount inductors may not be made to the required height.

The present invention has arisen to mitigate and/or obviate the afore-described disadvantages of the conventional surface mount inductors.

### SUMMARY OF THE INVENTION

The primary objective of the present invention is to provide a surface mount inductor including an improved structure having a suitable or decreased height and for being easily and quickly manufactured.

In accordance with one aspect of the invention, there is provided a surface mount inductor comprising a core including two erected side panels each having a conductor contact attached to a lower portion thereof for electrically coupling purpose, and including a central part coupled between the side panels for forming an H-shaped core, a wire wound around the central part of the core and including two terminals coupled to the conductor contacts of the core respectively for electrically coupling purpose, and a casing including a chamber formed therein and defined between a front plate and a rear plate and an upper plate for receiving the core.

The core is made of ferrite materials, or ceramic materials, and/or made by molding or mold-injection processes. The casing is also preferably made of ferrite materials, or ceramic materials, and/or made by molding or mold-injection processes.

The front plate and the rear plate of the casing are positioned on a front portion and a rear portion of the core, and the side panels and the central part of the core are disposed between and/or engaged with the front plate and the rear plate of the casing.

The side panels of the core are disposed on two open side portions of the casing for enclosing the chamber and the two open side portions of the casing, and for receiving the coiled wire within the chamber which is defined between the front plate and the rear plate of the casing and the side panels of the core.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a surface mount inductor in accordance with the present invention; and

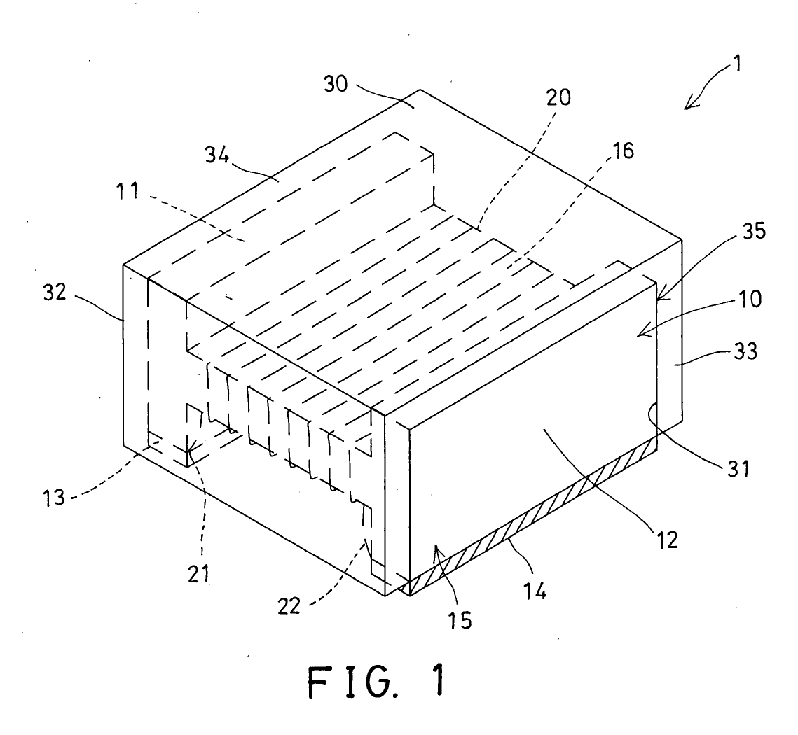

FIG. 2 is a partial exploded view of the surface mount inductor. illustrating the other arrangement of the surface mount inductor.

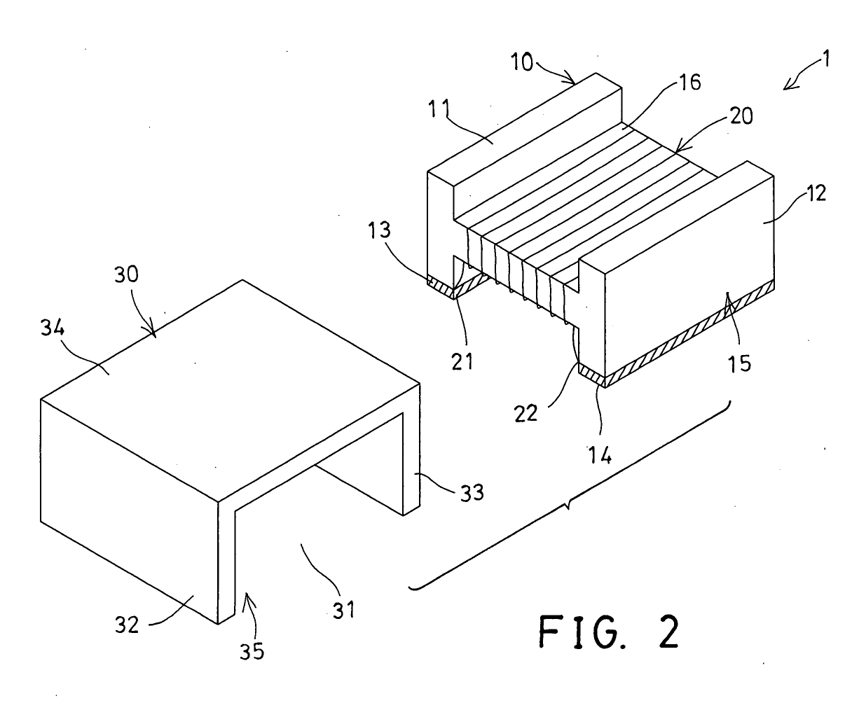

### DETAILED DESCRIPTION OF THE PREFERRED EMBODIMENT

Referring to the drawings, a surface mount inductor 1 in accordance with the present invention comprises a substantially H-shaped core 10 made of ferrite materials, ceramic materials or the like, and formed by such as molding or mold-injection processes, and including two vertical or erected side panels 11, 12 each having a conductor contact or welding material or member 13, 14 attached or secured to the lower or bottom portion 15 thereof for electrically coupling or securing to various electric circuit boards (not shown) or the like, and including a horizontal or central part 16 horizontally coupled between the side panels 11, 12 for forming the H-shaped core 10.

A wire 20 is wound around the horizontal part 16 of the core 10 and includes two ends or terminals 21, 22 coupled to the conductor contacts or welding materials or members 13, 14 of the core 10 respectively for electrically coupling to the electric circuit boards via the conductor contacts or welding materials or members 13, 14 of the core 10. A casing 30 includes a chamber 31 formed therein and defined between a front plate 32 and a rear plate 33 and an upper plate 34 for receiving the core 10 and for forming the surface mount inductor 1. The casing 30 may also be made of ferrite materials, ceramic materials or the like, and may also be formed by such as molding or mold-injection processes or the like.

It is preferable that the front plate 32 and the rear plate 33 of the casing 30 are disposed or arranged or positioned on the front and the rear portions of the core 10, and/or the side panels 11, 12 and the horizontal part 16 of the core 10 are disposed or arranged or positioned between the front plate 32 and the rear plate 33 of the casing 30, and/or the side panels 11, 12 of the core 10 are disposed or arranged or positioned on the two open side portions 35 of the casing 30 and preferably engaged with the front plate 32 and the rear plate 33 of the casing 30 for enclosing the chamber 31 and/or the two open side portions 35 of the casing 30, and thus for suitably receiving the coiled wire 20 within the chamber 31 that is now defined between the front plate 32 and the rear plate 33 of the casing 30 and the side panels 11, 12 of the core 10.

It is to be noted that the upper plate 34 of the casing 30 and the horizontal part 16 of the core 10 may include a suitable height or thickness such that the height of the present surface mount inductor may be made to the required or decreased height. Furthermore, the horizontal part 16 of the core 10 is opened such that the wire 20 may be easily and quickly engaged or wound onto and around the horizontal part 16 of the core 10 with various automatic machines or facilities (not shown).

Accordingly, the surface mount inductor in accordance with the present invention includes an improved structure having a suitable or decreased height, and for allowing the surface mount inductor to be easily and quickly manufactured.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A surface mount inductor comprising:
a core including two erected side panels each having a conductor contact attached to a lower portion thereof for electrically coupling purpose, and including a central part coupled between said side panels for forming an H-shaped core,
a wire wound around said central part of said core and including two terminals coupled to said conductor contacts of said core respectively for electrically coupling purpose, and
a casing including a chamber formed therein and defined between a front plate and a rear plate and an upper plate for receiving said core.

2. The surface mount inductor as claimed in claim 1, wherein said core is made of ferrite materials.

3. The surface mount inductor as claimed in claim 1, wherein said core is made of ceramic materials.

4. The surface mount inductor as claimed in claim 1, wherein said core is made by molding process.

5. The surface mount inductor as claimed in claim 1, wherein said casing is made of ferrite materials.

6. The surface mount inductor as claimed in claim 1, wherein said casing is made of ceramic materials.

7. The surface mount inductor as claimed in claim 1, wherein said casing is made by molding process.

8. The surface mount inductor as claimed in claim 1, wherein said front plate and said rear plate of said casing are positioned on a front portion and a rear portion of said core, and said side panels and said central part of said core are disposed between said front plate and said rear plate of said casing.

9. The surface mount inductor as claimed in claim 1, wherein said side panels of said core are disposed on two open side portions of said casing for enclosing said chamber and said two open side portions of said casing, and for receiving said coiled wire within said chamber which is defined between said front plate and said rear plate of said casing and said side panels of said core.

10. The surface mount inductor as claimed in claim 9, wherein said side panels of said core are engaged with said front plate and said rear plate of said casing.
